(19) United States
(12) Patent Application Publication
(10) Pub. No.: US 2018/0340620 A1
(43) Pub. Date: Nov. 29, 2018

(54) BALL VALVE AND SEALING ELEMENT FOR BALL VALVE

(71) Applicant: SCHAEFFLER TECHNOLOGIES AG & CO. KG, Herzogenaurach (DE)

(72) Inventors: Sven Wicher, Emskirchen (DE); Uwe Niebling, Diespeck (DE); Xin Liu, Shanghai (CN); Yuelin Zhang, Taicang (CN); Gilson Arima, Sorocaba (BR); Meng Li, Shanghai (CN); Huilan Zhou, Taicang City, Jiangsu (CN)

(73) Assignee: Schaeffler Technologies AG & Co. KG, Herzogenaurach (DE)

(21) Appl. No.: 15/777,786

(22) PCT Filed: Sep. 7, 2016
(86) PCT No.: PCT/CN2016/098326

§ 371 Date: May 21, 2018

(30) Foreign Application Priority Data
Nov. 19, 2015 (CN) 201510802493.5
Jun. 8, 2016 (CN) 201610405299.8

(51) Int. Cl. F16K 5/20; F16K 5/06; F16K 27/06

(52) U.S. Cl. CPC F16K 5/20; F16K 5/0678; F16K 27/067; F16K 5/0631

(57) ABSTRACT

A sealing element for a ball valve with a first sealing ring and a second sealing ring whose central axes are parallel, the first sealing ring and the second sealing ring being made of different materials, and the first sealing ring being located on a side of the second sealing ring facing towards a ball in a ball valve in an axial direction, and being used to make contact with a spherical surface of the ball to form a seat The first and second sealing rings are fixed together, and the first sealing ring is a stamped annular polytetrafluoroethylene (PTFE) sheet. Since PTFE has a very low friction coefficient, the friction torque between the first sealing ring and the spherical surface of the ball is relatively small, and the first sealing ring does not wear easily and is not prone to sealing failure. A ball valve using the sealing element is also disclosed.

The present application claims priority of Chinese Patent Application No. 201510802493.5, filed on 19 Nov. 2015 and entitled “Ball valve and sealing element for ball valve”, which is incorporated herein by reference in its entirety.

The present application claims priority of Chinese Patent Application No. 201610405299.8, filed on 8 Jun. 2016 and entitled “Ball valve and sealing element for ball valve”, which is incorporated herein by reference in its entirety.

### TECHNICAL FIELD

The present invention relates to the technical field of ball valves, and in particular to a ball valve and a sealing element for a ball valve.

### BACKGROUND

A ball valve can enable or disable the flow of a medium, and comprises a ball and a stem. Several channels for the medium to flow through are provided on a spherical surface of the ball. The stem is rotated to drive the ball to rotate to open or close a channel, so as to enable or disable the flow of the medium. A sealing element is arranged in the ball valve to prevent the medium from leaking from the spherical surface of the ball.

The sealing element comprises a first sealing ring and a second sealing ring that are arranged in parallel in an axial direction. The first sealing ring makes contact with the spherical surface of the ball to form a seal, to prevent the medium from leaking between a sealing surface of the first sealing ring and the spherical surface of the ball. The first sealing ring and the second sealing ring are made of different materials. The first sealing ring is made of polyvinylidene fluoride (PVDF).

However, PVDF has a relatively large friction coefficient, and the first sealing ring wears easily during the rotation of the ball relative to the first sealing ring, resulting in sealing failure.

### SUMMARY

The issue to be addressed by the invention is that the existing sealing element on a ball valve wears easily and thus causes sealing failure.

To resolve the foregoing issue, the invention provides a sealing element for a ball valve, the sealing element comprising a first sealing ring and a second sealing ring whose central axes are parallel, the first sealing ring and the second sealing ring being made of different materials, and the first sealing ring being located on a side of the second sealing ring facing towards a ball in the ball valve in an axial direction, and being used to make contact with a spherical surface of the ball to form a seal, wherein the first sealing ring and the second sealing ring are fixedly arranged, and the first sealing ring is a stamped annular polytetrafluoroethylene (PTFE) sheet.

Optionally, an annular sealing surface of the first sealing ring opposite the second sealing ring in the axial direction encloses a flaring opening.

Optionally, the sealing surface is a truncated conical surface.

Optionally, the sealing surface is a spherical surface whose curvature is equal to the curvature of the spherical surface of the ball.

Optionally, an annular concave cavity surrounding the central axis is arranged on a side of the first sealing ring facing towards the ball in the axial direction; and

the direction pointing from one axial end of the flaring opening to the other axial end is defined as an extending direction, and partial portions of the first sealing ring located on two sides of the annular concave cavity in the extending direction are both set to be suitable for making contact with the spherical surface, such that the annular concave cavity is suitable for enclosing an annular sealing cavity with the spherical surface.

Optionally, the sealing surface is a wavy curved surface, the wavy curved surface is formed by connecting several annular convex surfaces and annular concave surfaces alternately in the extending direction, the wavy curved surface has at least two annular convex surfaces and at least one annular concave surface, the annular concave surface encloses the annular concave cavity, and the partial portions are arranged on the annular convex surfaces; or,

the sealing surface is a spherical surface whose curvature is different from the curvature of the spherical surface of the ball, and the spherical surface on the first sealing ring encloses the annular concave cavity.

Optionally, the direction pointing from one axial end of the flaring opening to the other axial end is defined as an extending direction, and the first sealing ring comprises a first unit ring and a second unit ring arranged apart from each other in the extending direction; and

an annular concave cavity surrounding the central axis is arranged on a side of the second sealing ring facing towards the ball in the axial direction, the annular concave cavity in the extending direction is located between the first unit ring and the second unit ring, and the first unit ring and the second unit ring are both suitable for making contact with the spherical surface, such that the annular concave cavity is suitable for enclosing an annular sealing cavity with the spherical surface.

Optionally, sealing surfaces on the first unit ring and the second unit ring are both truncated conical surfaces; and

the sealing surfaces on the first unit ring and the second unit ring are both suitable for being tangent to the spherical surface in pre-contact; or,

the sealing surfaces on the first unit ring and the second unit ring are both suitable for when in pre-contact with the spherical surface, one end of each sealing surface near the annular concave cavity in the extending direction makes contact with the spherical surface, and the other end is arranged apart from the spherical surface.

Optionally, the thickness of the first sealing ring is less than 1 mm.

Optionally, the second sealing ring is a rubber ring, and the first sealing ring and the second sealing ring are fixed together by means of a vulcanization process.

Optionally, the sealing element further comprises: a frame ring, fixedly arranged with the second sealing ring on a radial inner side of the second sealing ring; and

an axial end portion of the frame ring far away from the first sealing ring in the axial direction folds outwardly in a radial direction to form an annular flange, the flange is located on an axial side of the second sealing ring, or a radial outer end of the flange is wrapped by the second sealing ring.

In addition, the invention further provides a ball valve, comprising: a ball having a spherical surface; and a sealing element according to any of the foregoing, the sealing surface of the first sealing ring making contact with the spherical surface of the ball to form a seal.

Compared with the prior art, the technical solution of the invention has the following advantage:

the first sealing ring is a stamped annular PTFE sheet. First, PTFE has a very low friction coefficient. Furthermore, PTFE is softer than PVDF. The first sealing ring can form a contact seal with the ball under a smaller acting force, so that the friction torque between the first sealing ring and the spherical surface of the ball is relatively small, and the first sealing ring does not wear easily and is not prone to sealing failure. In addition, the first sealing ring is formed by stamping, the processing is simpler than other types of processing, and the mass production of the first sealing ring can be achieved by using the same stamping die, greatly improving the production efficiency of the first sealing ring, and reducing the production cost of the first sealing ring.

### BRIEF DESCRIPTION OF THE DRAWINGS

FIG. 1 is a sectional view of a sealing surface of a first sealing ring and a spherical surface of a ball being in a state of contact after a sealing element is assembled on a ball valve in a first embodiment of the invention;

FIG. 2 is a sectional view of the sealing element in the first embodiment of the invention;

FIG. 3 is a sectional view of a sealing element in a second embodiment of the invention;

FIG. 4 is a sectional view of a sealing element in a third embodiment of the invention;

FIG. 5 is a sectional view of a sealing element in a fourth embodiment of the invention;

FIG. 6 is a sectional view of a sealing element in a fifth embodiment of the invention;

FIG. 7 is a sectional view of a sealing element in a sixth embodiment of the invention; and

sectional planes in all the sectional views are all a plane in which a central axis of a sealing element is located.

### DETAILED DESCRIPTION

To make the above objectives, features, and advantages of the invention more clearly understandable, specific embodiments of the invention are described below in detail with reference to the accompanying drawings.

### First Embodiment

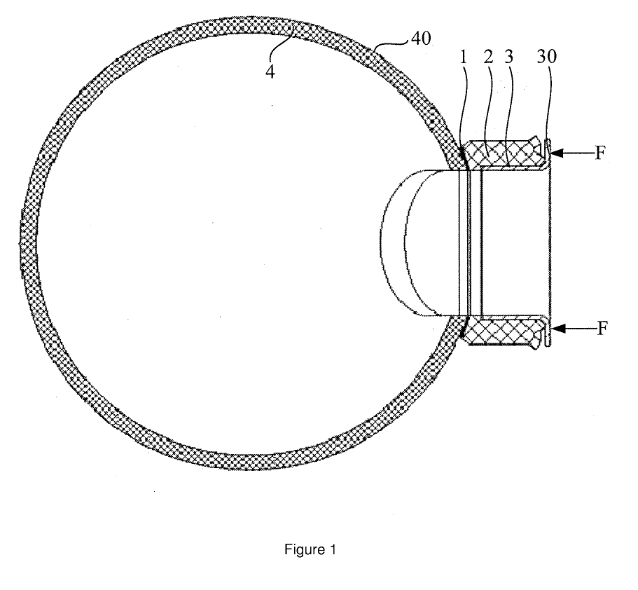

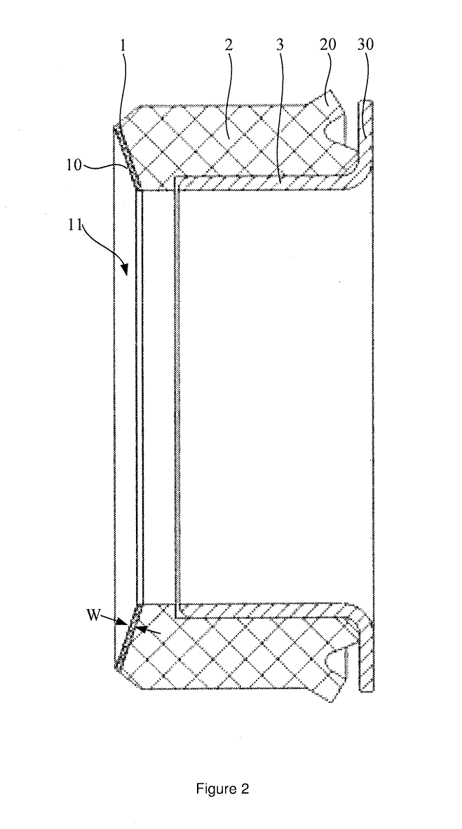

With reference to FIG. 1 to FIG. 2, this embodiment provides a sealing element for a ball valve. The sealing element comprises a first sealing ring 1 and a second sealing ring 2. The central axes (not shown) of the first sealing ring 1 and the second sealing ring 2 are parallel, and the first sealing ring and the second sealing ring are made of different materials. The first sealing ring 1 is located on a side of the second sealing ring 2 facing towards a ball 4 in the ball valve in an axial direction, and is used to make contact with a spherical surface 40 of the ball 4 to form a seal, so as to prevent a medium from leaking from the spherical surface 40 of the ball 4. In the technical solution of the invention, what is called the axial direction refers to the axial direction of the sealing element.

The first sealing ring 1 is a stamped annular PTFE (Polytetrafluoroethylene) sheet. That is, a stamping die is used to perform stamping processing on an annular PTFE raw material piece, to make the annular PTFE raw material piece deform plastically and form a required shape, and then the annular PTFE sheet can be obtained.

In the technical solution of the invention, the first sealing ring 1 is formed by means of a stamping process instead of other processes (for example, turning) because the stamping process has a processing process simpler than those of other processes, and the mass production of the first sealing ring 1 can be achieved by means of the same stamping die, greatly improving the production efficiency of the first sealing ring 1 and reducing the production cost of the first sealing ring 1.

First, PTFE has a very low friction coefficient. Furthermore, PTFE is softer than PVDF. The first sealing ring 1 can form a contact seal with the ball 4 under a smaller acting force, so that the friction torque between the first sealing ring 1 and the spherical surface 40 of the ball 4 is relatively small, and the first sealing ring 1 does not wear easily and is not prone to sealing failure.

After the sealing element is assembled on the ball valve, the sealing element is loaded with a pressing force F in the axial direction. The pressing force F is transferred from the second sealing ring 2 to the first sealing ring 1, so that the first sealing ring 1 deforms and a sealing surface 10 can stay in tight contact with the spherical surface 40 of the ball 4 to form a seal. Because the first sealing ring 1 and the second sealing ring 2 are fixed together, the second sealing ring 2 can securely hold the relatively thin sheet-shaped first sealing ring 1 against the spherical surface 40, to prevent the first sealing ring 1 from sliding off from the spherical surface 40 to cause sealing failure.

In the invention, the surface of the first sealing ring 1 used for making contact with the spherical surface 40 of the ball 4 is defined as an annular sealing surface 10. In this embodiment, an annular sealing surface 10 of the first sealing ring 1 opposite the second sealing ring 2 in the axial direction encloses a flaring opening 11. In the technical solution of the invention, what is called the flaring opening 11 refers to that diameter of the opening 11 tends to increase in the axial direction pointing from the second sealing ring 2 to the ball 4. The sealing surface 10 enclosing the flaring opening 11 better adapts to the shape of the spherical surface 40. After the sealing element is held against the spherical surface 40 of the ball 4 in the axial direction, a relatively large contact area can be obtained between the sealing surface 10 and the spherical surface 40, to implement a desirable seal.

Further, in one embodiment, the sealing surface 10 of the first sealing ring 1 is a truncated conical surface. When in pre-contact with the spherical surface 40, the sealing surface 10 and the spherical surface 40 nearly have line contact. In the technical solution of the invention, what is called the pre-contact refers to that although the first sealing ring 1 makes contact with the spherical surface 40, the first sealing ring 1 nearly does not deform. After the sealing element is assembled on the ball valve, under the effect of the pressing force F, the contact between the sealing surface 10 and the spherical surface 40 changes from line contact to surface contact.

In the technical solution in this embodiment, the benefit of setting the sealing surface 10 as a truncated conical surface is to facilitate processing of a stamping die, so that processing of the first sealing ring 1 is simpler.

In one embodiment, the surface (not shown) for making contact with the first sealing ring 1 in the second sealing ring 2 is also a truncated conical surface whose taper is equal to that of the sealing surface 10, so that different portions of the first sealing ring 1 have a uniform and consistent thickness, and the processing of the first sealing ring 1 is easier.

Many factors need to be considered to set the thickness W of the first sealing ring 1, for example, the raw material cost, the service life of the first sealing ring 1, and the capability of the sealing surface 10 to deform and make tight contact with the spherical surface 40 when the sealing element is loaded with a pressing force F. When the thickness W is larger, the raw material cost is higher, the service life of the first sealing ring 1 is longer, and the deformation capability of the sealing surface 10 is poorer when the sealing element is loaded with the pressing force F, resulting in poorer sealing performance. It has been found through research that when the thickness W of the first sealing ring 1 is set to be less than 1 mm, a desirable balance can be obtained between the raw material cost, the service life of the first sealing ring 1, and the deformation capability of the sealing surface 10. Of course, if the raw material cost, the service life of the first sealing ring 1, and the deformation capability of the sealing surface 10 do not need to be considered, the thickness W of the first sealing ring 1 may be not limited to this embodiment.

In one embodiment, the sealing element further comprises a frame ring 3. The frame ring 3 is fixedly arranged with the second sealing ring 2 on a radial inner side of the second sealing ring 2. An axial end portion of the frame ring 3 far away from the first sealing ring 1 in the axial direction folds outwardly in a radial direction to form an annular flange 30. The flange 30 is located on an axial side of the second sealing ring 2. After the sealing element is assembled on the ball valve, the pressing force F exerted on the sealing element is applied to the flange 30 through an elastic member (not shown) in a compressed state. The elastic member may be a spring.

In one embodiment, a sealing lip 20 extending outwardly at an inclination in the radial direction is provided on a side of the second sealing ring 2 opposite the first sealing ring 1 in the axial direction. What is called the inclination refers to that the sealing lip is not perpendicular to the central axis of the second sealing ring 2. There exists a space between the sealing lip 20 and the flange 30 in the axial direction. The sealing lip 20 is used to form a contact seal with a component (not shown) located on an outer side of the sealing element in the radial direction. The sealing lip 20 deforms after forming a contact seal with the component. The space between the sealing lip 20 and the flange 30 allows the sealing lip 20 to deform, so as to prevent the sealing lip 20 from interfering with the flange 30.

In one embodiment, the second sealing ring 2 is a rubber ring, and the first sealing ring 1 and the second sealing ring 2 are fixed together by means of a vulcanization process. In other embodiments, the second sealing ring 2 may be made of other materials different from PTFE, and the first sealing ring 1 and the second sealing ring 2 may also be fixed in another manner.

In one embodiment, the frame ring 3 and the second sealing ring 2 are fixed together in interference fit. Alternatively, the frame ring 3 and the second sealing ring 2 are fixed together by means of a vulcanization process. The latter fixing manner has the following advantages as compared with the former fixing manner: the medium cannot leak between the frame ring 3 and the second sealing ring 2. In other embodiments, the frame ring 3 and the second sealing ring 2 may also be fixed in another manner.

In one embodiment, the frame ring 3 is a metal ring.

### Second Embodiment

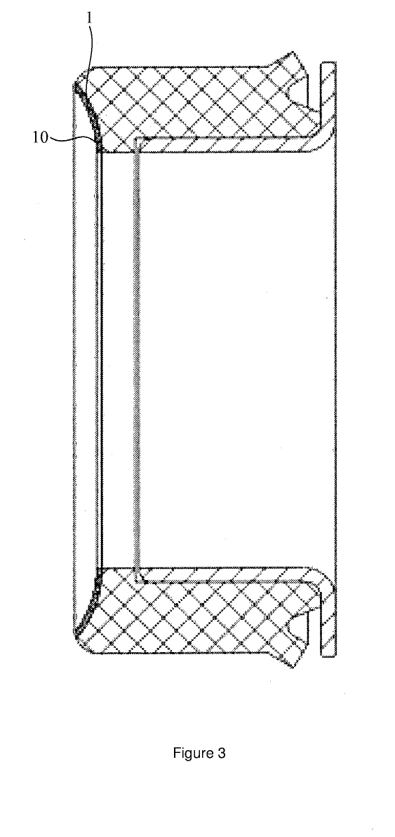

The differences between the second embodiment and the first embodiment are as follows: As shown in FIG. 3, in the second embodiment, the sealing surface 10 of the first sealing ring 1 is a spherical surface whose curvature is equal to the curvature of the spherical surface of the ball (not shown). That is, the shape of the sealing surface 10 matches the shape of the spherical surface of the ball. When the sealing surface 10 is in pre-contact with the spherical surface, the entire sealing surface 10 makes contact with the spherical surface. The benefit of configuring the sealing surface 10 as a spherical surface is that after the sealing element is assembled on the ball valve, a relatively small pressing force in the axial direction may be applied to the sealing element. In this way, it can still be ensured that the sealing surface 10 stays in tight contact with the spherical surface. Because the pressing force is relatively small, the friction torque between the first sealing ring 1 and the spherical surface is relatively small, further reducing the wear of the first sealing ring 1.

### Third Embodiment

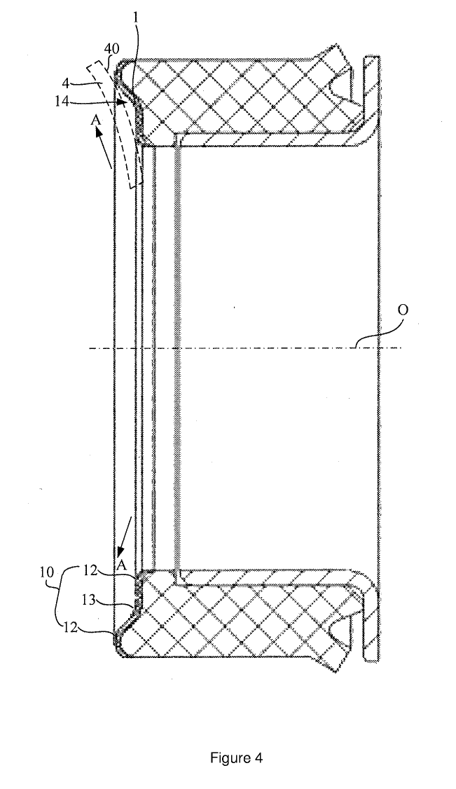

The differences between the third embodiment and the first embodiment are as follows: as shown in FIG. 4, in the third embodiment, an annular concave cavity 14 surrounding a central axis O is arranged on one side of the first sealing ring 1 facing towards the ball 4 in an axial direction (only a part is schematically shown with a dotted line in the figure). The direction pointing from an axial end of the flaring opening enclosed by the sealing surface 10 to the other axial end is defined as an extending direction A. After the sealing element is assembled on the ball valve, partial portions of the first sealing ring 1 located on two sides of the annular concave cavity 14 in the extending direction A both make contact with the spherical surface 40, such that the annular concave cavity 14 and the spherical surface 40 enclose an annular sealing cavity. When leaking from one of the partial portions, the medium flows into the annular concave cavity 14, and as a result the pressure of the medium decreases rapidly. In this case, under the sealing effect between the other partial portion and the spherical surface 40, the medium with rapidly decreased pressure can still be prevented from leaking, improving the sealing effect.

Specifically, in this embodiment, the sealing surface 10 of the first sealing ring 1 is a wavy curved surface. The wavy curved surface is formed by connecting several annular convex surfaces 12 and annular concave surfaces 13 alternately in the extending direction A. The wavy curved surface has at least two annular convex surfaces 12 and at least one annular concave surface 13. In the figure, an example in which two annular convex surfaces 12 and one annular concave surface 13 are arranged in the wavy curved surface is used. However, in the technical solution of the invention, the quantity of the annular convex surfaces 12 and the quantity of the annular concave surfaces 13 in the sealing surface 10 should not be limited to those in the figure.

The annular concave surface 13 encloses the annular concave cavity 14. Partial portions of the first sealing ring 1 located on two sides of the annular concave cavity 14 in the axial direction are respectively arranged on the two annular convex surfaces 12. After the sealing element is assembled on the ball valve, the two annular convex surfaces 12 both make contact with the spherical surface 40. The annular concave surfaces 13 and the spherical surface 40 have a space therebetween and enclose a sealing cavity.

In one specific embodiment, the sectional shapes of the annular convex surfaces 12 and the annular concave surface 13 in the radial direction of the first sealing ring 1 are sine waves. In other embodiments, the sectional shapes of the annular convex surfaces 12 and the annular concave surface 13 in the radial direction of the first sealing ring 1 may be set to be another curved surface shape such as an arc.

### Fourth Embodiment

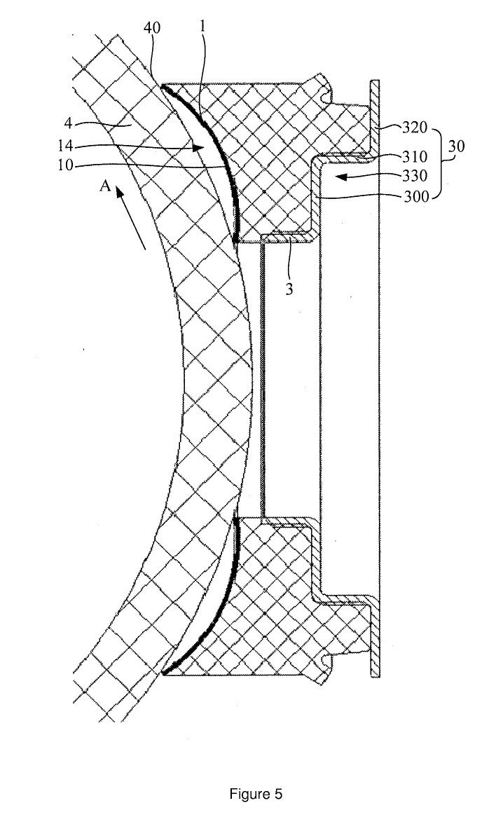

The differences between the fourth embodiment and the third embodiment are as follows: As shown in FIG. 5, in the fourth embodiment, the sealing surface 10 of the first sealing ring 1 is a spherical surface whose curvature is different from the curvature of the spherical surface 40 of the ball 4. The spherical surface on the first sealing ring 1 encloses the annular concave cavity 14, and the cross section of the annular concave cavity 14 in the radial direction is a bow shape. After the sealing element is assembled on the ball valve, two ends of the sealing surface 10 in the annular concave cavity 14 in the extending direction A both make contact with the spherical surface 40, and the annular concave cavity 14 and the spherical surface 40 enclose a sealing cavity.

In one embodiment, the flange 30 on the frame ring 3 comprises an annular radial extending portion 300, an annular axial extending portion 310, and an annular radial extending portion 320. The annular radial extending portion 300 is located on a radial inner side of the annular axial extending portion 310. The annular radial extending portion 320 is located on a radial outer side of the annular axial extending portion 310. Two axial ends of the annular axial extending portion 310 are respectively fixedly connected to an end of the annular radial extending portion 300 and an end of the annular radial extending portion 320.

The annular radial extending portion 300 and the annular axial extending portion 310 enclose a cavity 330. A spiral spring (not shown) in a compressed state may be arranged inside the cavity 330. An axial end of the spiral spring is held against the annular radial extending portion 300 for applying a pressing force in the axial direction to the sealing element, so as to securely hold the first sealing ring 1 against the ball 4. The annular axial extending portion 310 is used to exert a limiting effect on the spiral spring to prevent the spiral spring from shaking in the radial direction.

### Fifth Embodiment

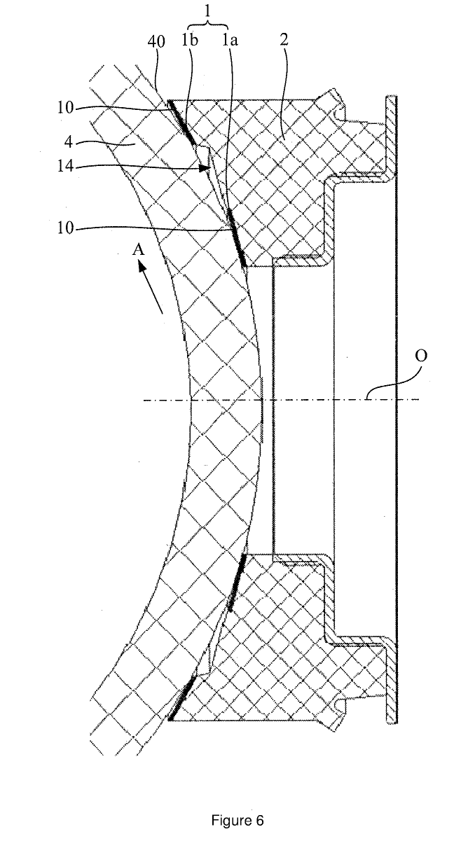

The differences between the fifth embodiment and the first embodiment are as follows: As shown in FIG. 6, in the fifth embodiment, the first sealing ring 1 comprises a first unit ring 1a and a second unit ring 1b arranged apart from each other in the extending direction A. The annular concave cavity 14 surrounding the central axis O is arranged on a side of the second sealing ring 2 towards the ball 4 in an axial direction. The annular concave cavity 14 is located between the first unit ring 1a and the second unit ring 1b in the extending direction A. The cross section of the annular concave cavity 14 in the radial direction of the sealing element is an obtuse triangle. After the sealing element is assembled on the ball valve, the first unit ring 1a and the second unit ring 1b both make contact with the spherical surface 40. The annular concave cavity 14 and the spherical surface 40 enclose a sealing cavity. When leaking from one of the unit rings, the medium flows into the annular concave cavity 14, and as a result, the pressure of the medium decreases rapidly. In this case, under the contact effect between the other unit ring and the spherical surface 40, the medium with rapidly decreased pressure can still be prevented from leaking, improving the sealing effect.

In one embodiment, sealing surfaces 10 on the first unit ring 1a and the second unit ring 1b are both truncated conical surfaces. When the first sealing ring 1 is in pre-contact with the spherical surface 40, the truncated conical surfaces on the first unit ring 1a and the second unit ring 1b are both tangent to the spherical surface 40, that is, in line contact. After the sealing element is assembled on the ball valve, under the effect of a pressing force in the axial direction, the contact between the truncated conical surfaces on the first unit ring 1a and the second unit ring 1b and the spherical surface 40 changes from line contact to surface contact.

### Sixth Embodiment

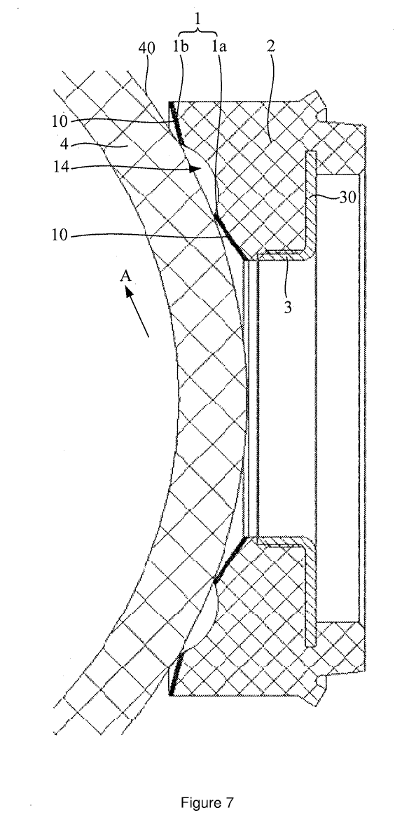

The differences between the sixth embodiment and the fifth embodiment are as follows: As shown in FIG. 7, in the sixth embodiment, the cross section of the annular concave cavity 14 in the radial direction on the second sealing ring 2 has a bow shape. The sealing surfaces 10 on the first unit ring 1a and the second unit ring 1b are both truncated conical surfaces. When the first sealing ring 1 is in pre-contact with the spherical surface 40, an end of the sealing surface 10 on the first unit ring 1a near the annular concave cavity 14 in the extending direction A makes contact with the spherical surface 40, and the other end is arranged apart from the spherical surface 40. An end of the sealing surface 10 on the second unit ring 1b in the extending direction A near the annular concave cavity 14 makes contact with the spherical surface 40, and the other end is arranged apart from the spherical surface 40.

In one embodiment, a radial outer end of the flange 30 on the frame ring 3 is wrapped by the second sealing ring 2, that is, the radial outer end of the flange 30 and the second sealing ring 2 are fixed together, so that the firmness of connection between the frame ring 3 and the second sealing ring 2 is enhanced.

It should be noted that in the technical solution of the invention, the shape of the annular concave cavity on the first sealing ring may be arbitrarily arranged, and should not be limited to what is in the given embodiments. In addition, the shapes of the first unit ring and the second unit ring should not be limited to those in the given embodiments, as long as when the first sealing ring makes contact with the spherical surface, the first unit ring and the second unit ring can both make contact with the spherical surface of the ball to form a seal. Moreover, the sealing surface on the first sealing ring is not required to enclose the flaring opening, and the shape of the sealing surface should also not be limited to what is in the given embodiments, as long as when the first sealing ring makes contact with the spherical surface, the area on the sealing surface making contact with the spherical surface is an annular closed area surrounding the central axis of the first sealing ring.

In all the foregoing embodiments, the surface in the second sealing ring making contact with the first sealing ring is set to have a shape the same as that of the sealing surface of the first sealing ring. However, it should be noted that, in other embodiments, the surface in the second sealing ring making contact with the first sealing ring may also be set to have a shape different from that of the sealing surface of the first sealing ring.

Based on the foregoing sealing element, the invention further provides a ball valve, comprising a ball having a spherical surface, a stem for driving the ball valve to rotate, and the foregoing sealing element. The sealing surface of the first sealing ring makes contact with the spherical surface of the ball to form a seat Several channels for the medium to flow through are provided on the ball. The stem is rotated to drive the ball to rotate to open or close a channel, so as to enable or disable the flow of the medium.

In one embodiment, the quantity of channels on the ball is one, and the ball valve has one inlet tube and one outlet tube. When the stem is rotated to the position at which the channel is misaligned with the inlet tube and the outlet tube, the channel is closed, and the ball valve disables the flow of the medium. When the stem is rotated to the position at which the channel is aligned with the inlet tube and the outlet tube, the channel is opened, and the ball valve enables the flow of the medium.

In another embodiment, the quantity of channels on the ball is two or more. The quantity of at least one of the inlet tube and the outlet tube on the ball valve is two or more. When the stem is rotated to a position at which any of the channels is misaligned with either of the inlet tube and outlet tube, the channel is closed, and the ball valve disables the flow of the medium. When the stem is rotated to a position at which one of the channels is aligned with one of the inlet tubes and one of the outlet tubes, the channel is opened, and the ball valve enables the flow of the medium. When the channel is aligned with different inlet tubes and outlet tubes, the flowing direction of the medium can be changed.

In the ball valve of the invention, the stem may be manually controlled or electrically controlled. When the stem is electrically controlled, the quantity of channels on the ball is two or more, and also the quantity of at least one of the inlet tube and the outlet tube on the ball valve is two or more, as one of the applications, the ball valve is used as a thermal management module (TMM for short), installed on an engine of an automobile, and used to control the flowing direction of a coolant, so as to warm up the engine when the temperature of the engine is slightly low and cool the engine when the temperature of the engine is slightly high, so that the engine can always work at suitable temperature. Of course, the ball valve provided in the invention may also be applied to other fields.

In the invention, the embodiments are provided in a progressive manner, in which the description focuses on portions that are different from the foregoing embodiments, and reference may be made to the foregoing embodiments for the same portions in the embodiments.

Although the invention is disclosed as above, the invention is not limited thereto. Any person skilled in the art can make various variations and modifications without departing from the spirit and scope of the invention. Therefore, the protection scope of the invention shall be defined by the claims.

1. A sealing element for a ball valve, the sealing element comprising a first sealing ring and a second sealing ring whose central axes are parallel, the first sealing ring and the second sealing ring being made of different materials, and the first sealing ring being located on a side of the second sealing ring that is adapted to face toward a ball in the ball valve in an axial direction, and being used to make contact with a spherical surface of the ball to form a seal,
the first sealing ring and the second sealing ring are arranged fixedly to one another, and
the first sealing ring is formed from a stamped annular polytetrafluoroethylene (PTFE) sheet.

2. The sealing element as claimed in claim 1, wherein the first sealing ring includes an annular sealing surface opposite to the second sealing ring in the axial direction that encloses a flared opening.

3. The sealing element as claimed in claim 2, wherein the sealing surface is a truncated conical surface.

4. The sealing element as claimed in claim 2, wherein the sealing surface is a spherical surface having a curvature that is equal to a curvature of the spherical surface of the ball.

5. The sealing element as claimed in claim 2, wherein the first sealing ring includes an annular concave cavity surrounding the central axis that is arranged on a side of the first sealing ring facing towards the ball in the axial direction; and
a direction pointing from one axial end of the flared opening to an other axial end is defined as an extending direction, and partial portions of the first sealing ring located on two sides of the annular concave cavity in the extending direction are both set to be suitable for making contact with the spherical surface, such that the annular concave cavity is adapted to enclose an annular sealing cavity with the spherical surface.

6. The sealing element as claimed in claim 5, wherein the sealing surface is a wavy curved surface, the wavy curved surface is formed by connecting several annular convex surfaces and annular concave surfaces alternately in the extending direction, the wavy curved surface has at least two annular convex surfaces and at least one annular concave surface, the annular concave surface encloses the annular concave cavity, and the partial portions are arranged on the annular convex surfaces.

7. The sealing element as claimed in claim 2, wherein the direction pointing from one axial end of the flared opening to the other axial end is defined as an extending direction, and the first sealing ring comprises a first unit ring and a second unit ring arranged spaced apart from each other in the extending direction; and
an annular concave cavity surrounding the central axis is arranged on a side of the second sealing ring facing towards the ball in the axial direction, the annular concave cavity in the extending direction is located between the first unit ring and the second unit ring, and the first unit ring and the second unit ring are both adapted to make contact with the spherical surface, such that the annular concave cavity is adapted to enclose an annular sealing cavity with the spherical surface.

8. The sealing element as claimed in claim 7, wherein sealing surfaces on the first unit ring and the second unit ring are both truncated conical surfaces; and
the sealing surfaces on the first unit ring and the second unit ring are both are adapted to be tangent to the spherical surface in a pre-contact position.

9. The sealing element as claimed in claim 1, wherein a thickness of the first sealing ring is less than 1 mm.

10. The sealing element as claimed in claim 1, wherein the second sealing ring is a rubber ring, and the first sealing ring and the second sealing ring are fixed together by vulcanization.

11. The sealing element as claimed in claim 1, wherein the sealing element further comprises: a frame ring, fixedly arranged with the second sealing ring on a radial inner side of the second sealing ring; and
an axial end portion of the frame ring located away from the first sealing ring in the axial direction folds outwardly in a radial direction to form an annular flange, and the flange is located on an axial side of the second sealing ring, or, a radial outer end of the flange is wrapped by the second sealing ring.

12. A ball valve, comprising:
a ball having a spherical surface; and
the sealing element as claimed in claim 1, the sealing surface of the first sealing ring making contact with the spherical surface of the ball to form a seal.

13. The sealing element as claimed in claim 5, wherein
the sealing surface is a spherical surface whose curvature is adapted to be different from the curvature of the spherical surface of the ball, and the spherical surface on the first sealing ring encloses the annular concave cavity.

14. The sealing element as claimed in claim 7, wherein the sealing surfaces on the first unit ring and the second unit ring are both adapted, when in a pre-contact position with the spherical surface, to have one end of each sealing surface near the annular concave cavity in the extending direction make contact with the spherical surface, and the other end arranged apart from the spherical surface.

15. A ball valve comprising:
a valve housing;
a ball having a spherical surface rotatably mounted in the valve housing; and
a sealing element comprising a first sealing ring and a second sealing ring fixedly connected to one another, the first sealing ring and the second sealing ring being made of different materials, and the first sealing ring being located on a side of the second sealing ring that faces toward the spherical surface of the ball, and the first sealing ring includes a sealing surface that contacts the spherical surface of the ball to form a seal, and the first sealing ring is formed from a stamped annular polytetrafluoroethylene (PTFE) sheet.

16. The ball valve as claimed in claim 15, wherein the sealing surface is a truncated conical surface.

17. The ball valve as claimed in claim 15, wherein the sealing surface is a spherical surface having a curvature that is equal to a curvature of the spherical surface of the ball.

18. The ball valve as claimed in claim 15, wherein the first sealing ring includes an annular concave cavity surrounding the central axis that is arranged on a side of the first sealing ring facing towards the ball in the axial direction; and
a direction pointing from one axial end with the second sealing ring to an opposite axial end with the first sealing ring is defined as an extending direction, and partial portions of the first sealing ring located on two sides of the annular concave cavity in the extending direction both contact with the spherical surface, such that the annular concave cavity encloses an annular sealing cavity with the spherical surface.
